(19) United States
(12) Patent Application Publication
(10) Pub. No.: US 2002/0169654 A1
(43) Pub. Date: Nov. 14, 2002

(54) Method and system of determining differential promotion allocations

(76) Inventors: Cipriano A. Santos, Mountain View, CA (US); Dirk M. Beyer, Mountain View, CA (US); Troy Shahoumian, Sunnyvale, CA (US); Bilal Iqbal, Mountain View, CA (US); Harlan Crowder, Sunnyvale, CA (US); Vineet Singh, Cupertino, CA (US)

Correspondence Address: HEWLETT-PACKARD COMPANY, Intellectual property Administration, P.O. Box 272400, Fort Collins, CO, 80527-2400, US

(21) Appl. No.: 09/851,514

(22) Filed: May 8, 2001

(51) Int. Cl. G06F 17/60

(52) U.S. Cl. 705/10; 705/14

(57) ABSTRACT

The offerings of promotions to prospective customers are differentially allocated on the basis of customer segmentation, which is a mapping of the customers to a smaller number of segments that reflect commonalities of purchasing attributes. An optimization engine includes inputs of customer segment information, promotion information, market information, management information, and supply chain information. The various forms of information are utilized to provide promotion strategies on a promotion-by-promotion basis and a segment-by-segment basis. Preferably, the market information includes “null promotion data” for the individual customer segments. The null promotion data relates to conversion probabilities, revenues and costs for those occasions on which there are no promotions offered to the customers.

### TECHNICAL FIELD

The invention relates generally to computational methods and systems for determining a promotion strategy and relates more particularly to designing a campaign plan for differential allocation of promotions among prospective customers of a business enterprise.

### BACKGROUND ART

With the widespread deployment of the global communications network referred to as the Internet, the capability of providing electronic service (e-service) has become important to even well-established traditional business entities. An “e-service” is an on-line service that markets goods or services, solves problems, or completes tasks. E-services are accessible on the Internet by use of a particular Uniform Resource Locator (URL).

Operators of e-services are often interested in inducing visitors of a website to act in a certain manner. For example, an operator (i.e., e-marketer) may be interested in the sale of goods or services to visitors or may merely request that visitors register by providing selected information.

When a visitor acts in the desired manner, the event may be considered (and will be defined herein) as a “conversion.” The ratio of visitors who are converted to the overall number of visitors is referred to as a “conversion rate.” Presently, conversion rates at Internet websites are relatively low, typically in the range of 2 percent to 4 percent. Operators of a particular e-service provider are interested in methods of increasing the conversion rates for those websites maintained by the e-service provider.

Clearly, conversion rates can be significantly increased by offering rewards to interact with a website in a desired manner, e.g., register or purchase a product. Promotional offers include providing a discount on the price of the product being sold, providing free shipping and handling of the product, and/or providing a cost-free item. While such promotions may be used to increase conversion rates, the increases are achieved at the sacrifice of profitability. Thus, the typical goal of a promotion campaign plan is to increase the conversion rate in a cost-efficient manner.

Methods of designing customer-specific promotion campaign plans are known. U.S. Pat. No. 6,185,541 to Scroggie et al. describes a system and method for delivering purchasing incentives through a computer network, such as the World Wide Web. Customers of retail stores can establish bidirectional communication links with the system, log-in to the system, and then browse through a catalog of goods and incentive offers. In one embodiment, the incentives are targeted to specific consumers based upon consumer purchase histories. Each customer is associated with a customer ID which may be a check cashing card number or a customer loyalty card number. Using the customer ID, the purchasing history of each customer can be consistently maintained. Thus, focused incentives are enabled. In one stated example, a customer may receive an incentive for his or her preferred brand of toothpaste, based on the prior purchases of the same toothpaste. Another method of presenting incentives to particular individuals is described in U.S. Pat. No. 5,710,887 to Chelliah et al. A visitor of a website may be presented with an incentive, such as a price discount. The offers of incentives and the individual consumers must be closely tracked.

Another approach is employed by Marketswitch, Inc and is sold under the trademark MARKETSWITCH TRUE OPTIMIZATION. The term “optimization” is used in this art to identify a mathematical methodology for allocating limited resources. With regard to forming a promotion campaign plan, optimization is mathematically based software that allocates finite marketing resources across various channels (e.g., e-mail and website access) in view of different business constraints and marketing scenarios, with a goal of targeting the right customer with the right product through the right channel. The approach of Marketswitch, Inc is to “score” each customer on the basis of a number of factors. Thus, customer-level information is utilized in this approach. The score of a customer is indicative of the propensity of the customer to accept a particular offer. The variables that are used in determining the scores are relevant to the purchasing habits of the potential customers. Variables may include age, income, gender, mortgage ownership, child/childless, and transaction history. While the approach operates well for its intended purpose, the programming models that are used in the optimization can be processing intensive and data storage intensive when used on a large scale. For example, if an e-commerce provider has one million registered customers, the necessary storage capacity is significant. Moreover, the programming models used with customer-level scores limit the flexibility and the scalability of the system.

What is needed is a method and system for providing differential promotion allocation among prospective customers, such as visitors to a website, with manageable levels of storage and processing requirements.

### SUMMARY OF THE INVENTION

Customer segmentation is used as one basis for mathematically deriving a campaign plan for allocating the presentation of promotions, with other factors including business management parameters such as business objectives and budget constraints. The customer segmentation is a mapping of visitors to a smaller number of segments to reflect commonality of attributes perceived to be relevant to customer activity. The desired activity may be the completion of a registration sequence or may be transactional, such as the purchase of goods or services (collectively, “product”).

The term “campaign” will be used herein as a rule set that determines which marketing action (e.g., promotions, information distribution, and the like) to present to which customers. The present invention utilizes an approach that assumes that customers are grouped into sets of individuals who react similarly to marketing actions. These groups are referred to as “customer segments” in which each group may be considered to be representative of a surrogate customer having “average” behavior for that segment. The advantages to this approach, assuming that the segmentation is properly implemented, include the fact that statistical data for the individuals within a segment can be more reliable and that global optimization over a segmented customer base is much more scalable and can be more easily extended to consider new business objectives and new business constraints.

In the system approach of the invention, an “optimization” engine has inputs of stored customer segment information, stored promotion information, stored market information, and stored management information. The various forms of information are utilized to provide promotion strategies on a promotion-by-promotion basis and segment-by-segment basis. In order to achieve global objectives for the campaign, while honoring global constraints, it is in general necessary to allocate a given promotion to a fraction of the customers within a particular segment. In general, a campaign can be expressed as a table in which the rows represent segments and the columns represent marketing actions. Each cell in the table holds an assigned percentage representing the percentage of customers in the segment that is to be presented with the marketing action. As an example, there may be ten customer segments and each customer segment may have a different designated percentage of customers who will be made aware of the promotion (e.g., ranging from 20% for Segment1 to 40% for Segment10).

The management information includes data indicative of budget constraints for both the overall campaign plan and the individual promotions within the plan. The data indicative of the budget constraints preferably also includes information regarding the individual customer segments. Additional constraints on the number of promotions for a given segment and the expected number of promotion “accepts” can be specified. The management information also specifies a number of objectives. The objectives may include target profit, target revenue, and the number of conversions (e.g., purchases of a promoted product). Mathematical optimization is then used to allocate promotions to customer segments, honoring these constraints and optimizing the objectives.

The system may include an efficiency frontier engine that is configured to cooperate with the optimization engine to resolve trade-offs among the business objectives. The initial setup by the user may provide the parameters for the resolution. Thus, a hierarchy of objectives is established by the system or the user. As an example, a main business objective may be to maximize profit, while a secondary business objective may be to increase revenue. By specifying a maximum profit reduction (e.g., a 10% reduction in profit), the system is able to identify and implement a desired trade-off in the allocation of promotion opportunities.

The system also includes a feasibility engine that is configured to recognize and address inconsistencies within the management information. Since the management information is defined by the e-marketer, there may be inconsistencies. Such inconsistencies are reported and corrected by the feasibility engine. The feasibility engine may have a built-in hierarchy to correct budget infeasibilities, but the e-marketer may enter a different hierarchy.

Marketing information includes data indicative of the propensities of customers in a given segment to take advantage of a marketing action. In addition, marketing information includes expected cost and revenue data resulting from the consumption of the market action. Marketing information also includes data concerning segment sizes and arrival rates of customers in a given segment.

Preferably, the market information also includes “null promotion data” for the individual customer segments. The null promotion data may take a number of forms. The conversion probability of a null promotion is defined as an estimate of the probability that a customer in a particular segment will buy a product (i.e., goods or service) without being presented with any promotion for the product. The null promotion revenue for the purchase of a product by a customer in a particular segment is the revenue that would be obtained in the purchase if the customer were not presented with any promotion. The null promotion cost is the cost incurred by the promoting company as a result of the purchase of a product by a customer without having been presented with any promotion of the product. This null promotion cost is typically the cost of the product. On the other hand, the promotion cost is the cost that results from the purchase of the product by a customer after having been presented with the promotion. This promotion cost may include the cost of the original product plus the cost of the promotion, which may merely be free shipping and handling or may be a promotional add-on product. The null promotion data provides information that is relevant to a true optimization of promotion allocation.

Another input to the optimization engine is supply information. The supply information reflects the currently available inventory of a product and the on-order inventory. Thus, the system is aware of the supply chain data. The campaign plan is adjusted in order to reflect the supply chain information, so that customer satisfaction is maintained. In the reverse direction, the execution of the campaign plan may be used to forecast requirements. Thus, the expected number of conversions and associated revenues can be considered in demand forecasts and revenue forecasts over the duration of the campaign.

While the invention is well suited for application to the presentation of promotions via a website, the method and system may be used in other applications. For example, the invention may be used for optimization within a call center or optimization in presenting promotions via electronic mail (e-mail) or regular postal mail. Other applications have also been contemplated.

### BRIEF DESCRIPTION OF THE DRAWINGS

FIG. 1 is a schematic representation of an Internet-enabled system for implementing promotion allocation in accordance with one possible application of the invention.

FIG. 2 is a block diagram of components for designing and executing a promotion campaign plan within the system of FIG. 1, with the components including the optimization stage that represents the present invention.

FIG. 3 is a block diagram of components for defining the campaign plan within the optimization stage of FIG. 2.

### DETAILED DESCRIPTION

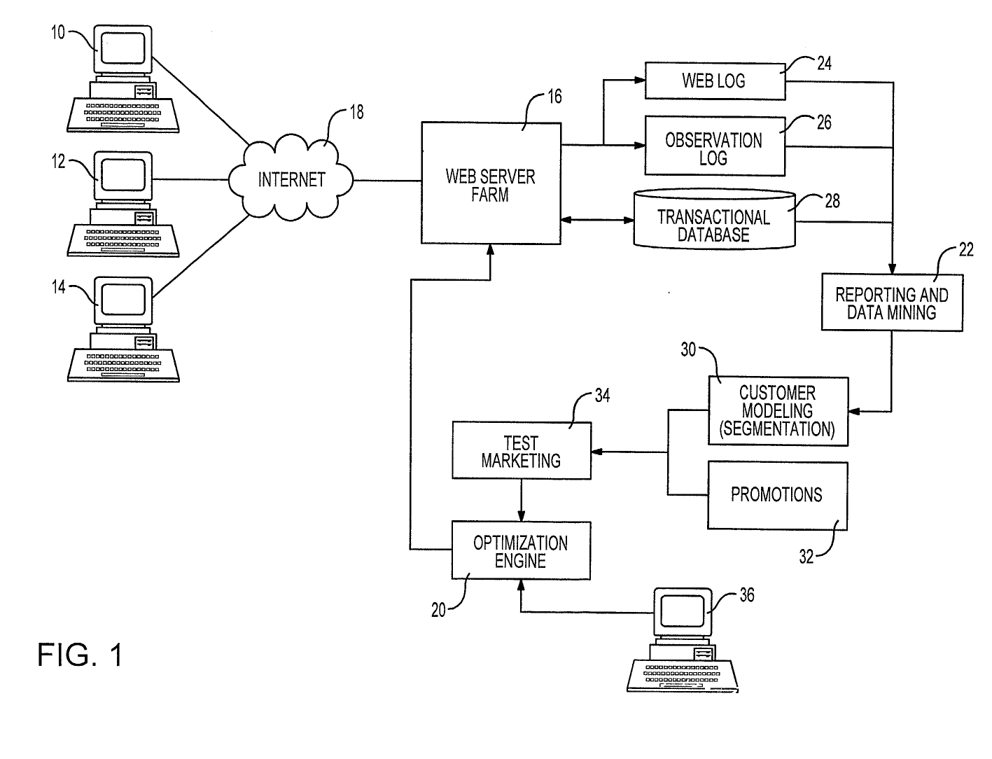

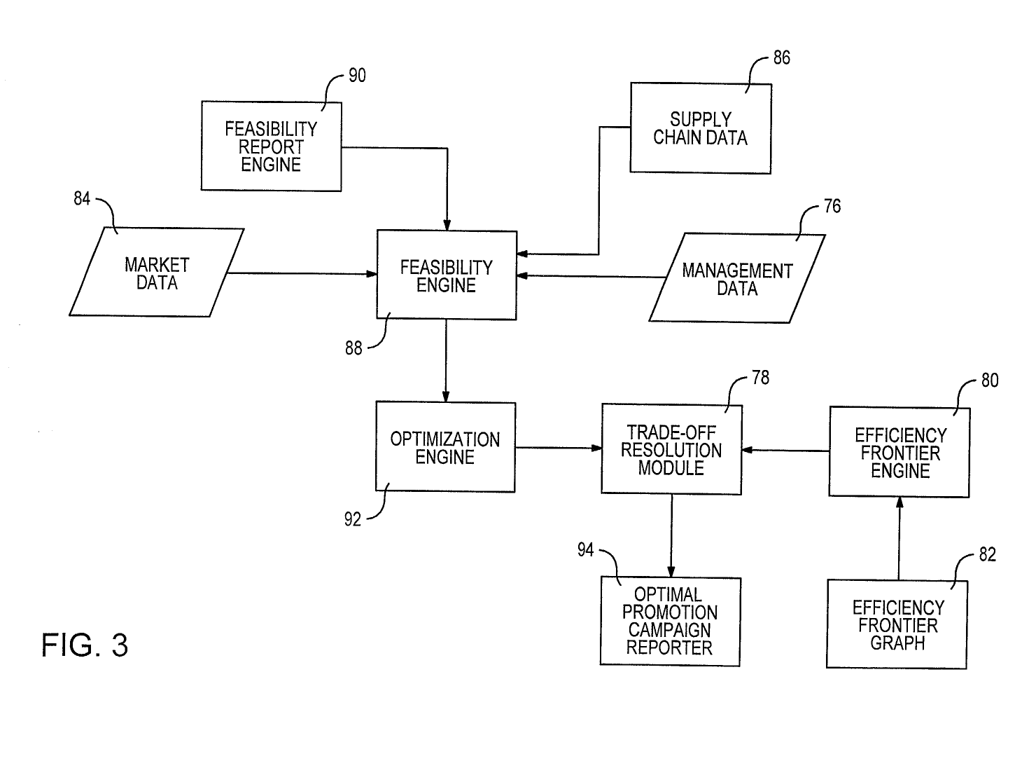

With reference to FIG. 1, a number of clients 10, 12 and 14 are shown as being linked to a web server farm 16 via the global communications network referred to as the Internet 18. The web server farm may include a number of conventional servers, or may be a single server which interfaces with the clients via the Internet. The clients may be personal computers at the homes or businesses of potential customers of the operators of the web server farm. Alternatively, the clients may be other types of electronic devices for communicating with a business enterprise via a network such as the Internet. The common feature for applications of the invention is that a customer population can be broken into different segments, with the customers in a particular segment being similar with regard to their responsiveness to promotions. While the possible applications of the invention of FIG. 3 extend beyond presenting promotions over a website, the invention will be described in the environment of FIG. 1.

The operators of the web server farm 16 are e-marketers for selling goods and/or services (“products”). The types of products are not critical to the use of the invention. The tool to be described below optimizes the increased value derived from the conversions of customers when promotions are offered to the customers. A conversion is the act in which a visitor to a network site, such as a website, acts in a certain manner, such as purchasing a product or registering information. A “null promotion” of a product is a conversion that occurs without the presentation of a promotion.

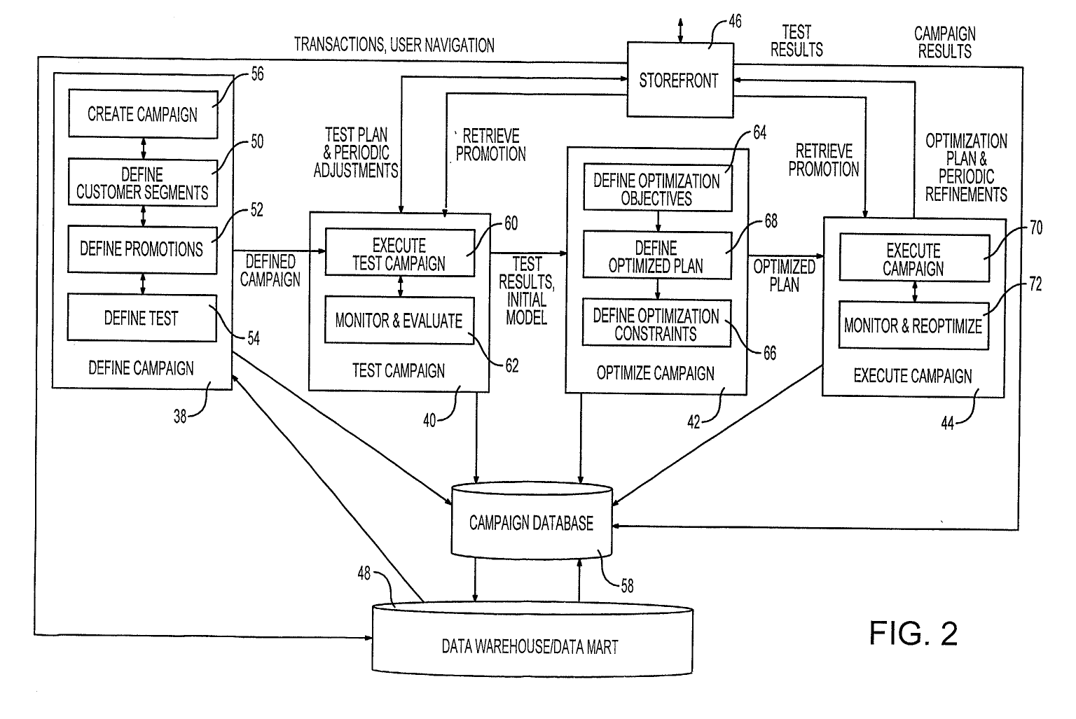

The campaign plan for determining which promotion should be presented to which customers is mathematically determined by an optimization engine 20. The design parameters will be described below in greater detail with reference to FIGS. 2 and 3. Information may be acquired using known techniques. A reporting and data mining component 22 receives inputs from a conventional web log 24, observation log 26, and transactional database 28. The logs 24 and 26 acquire information either indirectly or directly from the customers at the clients 10, 12 and 14. Indirect information includes the Internet Protocol (IP) address of the client device. As information is acquired, the IP address may be used to identify a particular customer or a particular geographic area in which the client device resides. The indirect information may be obtained from conventional “cookies.” On the other hand, direct information is intentionally entered by the client. For example, the client may complete a questionnaire form or may enter identification information in order to receive return information.

The transactional database 28 is a storage component for the customer-related data. When a customer enters into a particular transaction with a business enterprise that is the operator of the web server farm 16, billing information is acquired from the customer. The billing information is stored at the transactional database. As more transactions occur, a customer history may be maintained for determining purchasing tendencies regarding the individual customer. The various customer histories can then be used to deduce common purchasing tendencies and common tendencies with regard to reacting to promotions, so that customer modeling may occur at the segmentation component 30 of the system. Customer segmentation is preferably based upon a number of factors, such as income, geographical location, profession, and product connection. Thus, if it is known that a particular customer previously purchased a specific product, the purchase may be used in the algorithmic determination of segments.

A promotions component 32 includes all of the data regarding available promotions. The types of promotions are not critical to the invention. Promotions may be based upon discounts, may be based upon offering add-on items in the purchase of a larger scale item, may be based upon offering future preferential treatment (e.g., a “gold member”) or may be based upon other factors (e.g., free shipping and handling).

A test marketing component 34 provides feedback to the optimization engine, so that initial determinations may be made or fine tuning may occur. Interaction with the design of a promotion campaign plan by a business manager takes place via a workstation 36. Thus, the business manager may enter information regarding parameters such as budget constraints, business objectives, costs and revenues.

FIG. 2 illustrates the four stages of a promotion campaign plan. In a first stage 38, an initial campaign is defined. The defined campaign is passed to a stage 40 for testing the plan. The test results and an initial model are passed to an optimization stage 42. It is at this stage that the invention is implemented, but the specifics of the optimization stage will be described below, when referring to FIG. 3. The optimized campaign plan is passed to the execution stage 44. This execution stage interacts with storefront software 46, such as that offered by Broadvision of Los Altos, Calif. The storefront 46 may be run on the web servers of the farm 16 of FIG. 1, so that the clients 10,12 and 14 may link with the system using conventional techniques, such as an Internet navigator. While the invention will be described with respect to interaction among the four stages, the optimization stage 42 that is the focus of the invention may be used in other architectures and in non-Internet environments.

A number of actions take place within the campaign definition stage 38. Necessary information is retrieved from a data warehouse 48. One source of information for the data warehouse is the connection to the storefront 46. This connection allows the transactions with customers to be monitored. As relevant information is recognized, the information is stored. This information can then be used to define the customer segments, as indicated at component 50 within the campaign definition stage 38. Within this stage, the promotions are defined 52 and the tests for ascertaining the effectiveness of the promotions are defined 54. Thus, the initial model of the campaign can be created 56. This initial campaign plan is stored at a campaign database 58.

Within the test stage 40, the tests that are defined within the component 54 of the definition stage 38 are executed at the execute test campaign component 60. Typically, the test campaign is executed by means of interaction with customers via the storefront 46, but other techniques may be employed. The execution of the test campaign is monitored and evaluated at step 62 of the test stage 40. Periodic adjustments to the campaign plan may be made during this stage. Preliminary and final results are communicated with the campaign database 58, while the final results are communicated with the optimization stage 42.

The optimization stage 42 will be described broadly with reference to FIG. 2, but will be described in greater detail below with reference to FIG. 3. Briefly, the stage includes defining the optimization objectives 64 (i.e., business objectives) and the optimization constraints 66, so that an optimized campaign can be identified at component 68 of the stage. The optimized plan is stored at the campaign database 58 and is transferred to the execution stage 44.

As previously noted, the execution of the optimized plan utilizes the storefront 46. Preferably, in addition to an execution component 70, the stage 44 includes a capability 72 of monitoring and reoptimizing the plan. Thus, interactions with customers are monitored to recognize changes in dynamics which affect the optimization plan. The reoptimization is a reconfiguration that is communicated to the campaign database 58.

Referring now to FIG. 3, the structural layout of the optimization system includes three sources of data and includes a number engines. One data source is a store 76 of management data. The management data is a set of parameters defined by the e-marketer who configures the business framework for the execution of the promotion campaign plan. The management data may be entered using the workstation 36 shown in FIG. 1. The management data includes promotion information, business objective information, and business constraint information. The promotion information may merely be promotion identification numbers and descriptions, as well as promotion awards (e.g., discounts). The business objective information can include a hierarchy of different business objectives, such as a ranking of profit, revenue, and conversion ratio. Such a hierarchy enables a trade-off resolution module 78 to be enabled to handle inevitable trade-offs between business objectives. For example, if profit is identified as a main business objective, while revenue is identified as a secondary business objective, conflicts can be resolved using an efficiency frontier engine 80. The engine 80 determines the “optimal” trade-offs between the main business objective and the secondary business objective. Suppose there is a maximum profit of X and the e-marketer has identified the maximum acceptable profit “loss” as 10%. As a result, the secondary business objective of revenue is to maximize the revenue subject to the constraint that at least X×90% of profit is to be realized. The main output of the efficiency frontier engine 80 is a trade-off graph 82, which is also referred to as the efficiency frontier graph of the main and secondary objectives.

Business constraints and rules preferably include the minimum and maximum overall campaign budget limits and the minimum and maximum limits for the individual customer segments. Thus, the allocation of the different promotions may be determined on a segment-by-segment basis. Business constraints and rules may also include the maximum number of promotions to be offered to a particular customer in a given segment, as well as the minimum number of customers in a segment that are to be offered a particular promotion. This lower limit may be a minimum sample size in order to improve accuracy of market data to be collected during the test stage 40. Business rules may also include the customer eligibility for a particular promotion.

The arrangement of FIG. 3 also includes a store 84 of market data. This data is collected during the testing stage 40 or is acquired historical data. The data includes the mapping of each customer to a specific customer segment. Conversion probabilities are also stored. An estimated probability is the probability that a customer in a particular segment will “convert” (e.g., purchase a product) after being presented with a specific promotion. Segment size is the number of customers in a segment for whom a promotion has not been offered and has not been converted. The market data preferably also includes “null promotion data.” Promotion revenue is the revenue acquired from the purchase of a product by a customer in a segment after seeing a promotion, while null promotion revenue is the revenue from the purchase of the same product by a customer in the same segment without any offer of a promotion of the product. Promotion costs are those that result from the purchase of a product by a customer in a segment after seeing a promotion, while null promotion costs are those resulting from the purchase of the same product by a customer in the same segment without a promotional offer. The promotion cost typically is the sum of the product cost and the cost of offering and accepting the promotion (e.g., free shipping and handling). The null product cost typically is only the cost of the product.

A third store 86 includes the supply chain data. The supply chain data includes the information regarding on-hand inventories and on-order inventories. In addition, the data may include measurement variables regarding replenishing product when inventory is depleted. While not shown in FIG. 3, the supply chain data is shared by a supply chain system which uses the optimization system of FIG. 3 to forecast procurement needs. That is, the purchase of inventory may be at least partially based upon the campaign plan for promoting the purchase of products. With regard to the flow of supply chain data to the supply chain system, the advantage is that a greater amount of information is available to the approach of determining when to order product and determining the volume of product to be ordered. On the other hand, with regard to the flow of supply chain data to the optimization system, the advantage is that products are less likely to be promoted when there are availability problems. Thus, customer satisfaction is improved during promotion campaigns.

The three stores 76, 84 and 86 of data provide inputs to a feasibility engine 88. This engine automatically identifies contradictions. Since the management data 76 is defined by the e-marketer, it may contain one or more contradictions, such as a conflict between two business constraints. A contradiction is distinguishable from a trade-off described with reference to the module 78, since contradictory considerations conflict and are typically mutually exclusive, so that only one such consideration can be achieved. The feasibility engine 88 is connected to a report engine 90 that reports the contradictions and any corrections which are automatically determined by the feasibility engine 88. The report engine 90 is connected to the management workstation 36 of FIG. 1, so that the contradictions and the corrections may be viewed. The feasibility engine 88 may include a built-in (i.e., default) hierarchy for automatically correcting budget infeasibilities. However, a different hierarchy may be entered by the e-marketer.

The output of the feasibility engine 88 is an input to the optimization engine 92, which provides an input to the trade-off resolution module 78. As previously noted, this module detects and addresses inconsistencies between business objectives. The operations of the optimization engine 92 and the trade-off resolution module determine allocations of promotions to customer segments in such a way that the increased values of the main business objective and any secondary business objectives are maximized, while the business constraints and rules are satisfied. In particular, budget constraints are the instrument for the e-marketers to drive and provide stability for the promotion campaign plan during reoptimization that occurs at the execution stage 44 of FIG. 2, as noted with regard to the reoptimization component 72.

As an example of the use of the trade-off resolution module 78, after initial market data is entered into store 84, the e-marketer may run the optimization engine 92 without entering budget constraints. The optimization engine will then determine an overall maximum budget for the unconstrained parameter. This initial budget may be cost prohibitive. Thus, the efficiency frontier engine 80 will determine an efficiency frontier between the main business objective and the maximum overall budget, where the maximum overall budget varies discretely from zero to the value of the initial budget.

The main output of the system of FIG. 3 is the optimal number of customers in each segment that will be offered a promotion. An optimal promotion campaign plan is generated and reported using the reporter element 94. All output reports can be calculated from this main output. The output reports generated include (1) an optimal main business objective value, (2) budgets for promotional campaign implementation, (3) fractions of customers in each segment to be offered a promotion, (4) the expected number of customers in each segment that will accept each promotion offer, and (5) the expected profit by promotion.

An advantage of the use of the customer segmentation is that the optimization engine 92 can be run using linear programming on the customer base, rather than using a more complicated integer programming model. The integer programming models may be used in applications in which each customer receives a “score,” so that there is a one-to-one correspondence between scores and customers. In some applications, the customer segmentation and linear programming may be less precise than the customer scoring and integer programming, but the use of linear functions enables reoptimization “on the fly.” Nevertheless, the use of linear programming is not critical to the invention. In fact, mixed integer programming is often preferred. Other techniques for providing trade-off analysis and promotion optimization include integer programming, dynamic programming, and meta-heuristic approaches (e.g., genetic programming and simulated annealing).

What is claimed is:

1. A computerized method of determining differential promotion allocation among prospective customers comprising the steps of:
entering management information that is specific to business management objectives and constraints, including entering budget information; and
defining a campaign plan for allocating presentations of a plurality of said promotions among said customers, including using automated processing to form said campaign plan on the basis of customer segments and said management information, said customer segments being based upon customer commonalities with respect to at least one customer attribute, said campaign plan being defined to include at least one restricted promotion for which each customer segment is assigned a specific percentage and at least one specific percentage is less than an entirety of said customer segment, each said specific percentage representing that portion of said customers from said customer segment that is to be presented with said restricted promotion.

2. The method of claim 1 wherein said step of defining said campaign plan includes:
automatically identifying an inconsistency in achieving two of said business management objectives;
automatically determining a guideline for resolving a trade-off between said two business management objectives; and
utilizing said guideline in configuring said campaign plan.

3. The method of claim 1 wherein said step of defining said campaign plan includes:
automatically detecting contradictions between said constraints and other aspects of said entered management information;
automatically identifying resolutions to said contradictions; and
implementing said resolutions in said campaign plan.

4. The method of claim 3 wherein said step of automatically detecting said contradictions includes generating a report which identifies said contradictions and said resolutions.

5. The method of claim 1 wherein said step of entering said management information includes entering data indicative of budget constraints (1) for individual said customer segments and (2) for said overall campaign plan.

6. The method of claim 1 wherein said campaign plan is specific to application via the global communications network referred to as the Internet.

7. The method of claim 1 wherein said campaign plan is specific to application via a telecommunications network.

8. The method of claim 1 further comprising a step of entering market data on which said campaign plan is further based, including entering conversion data that is indicative of the responsiveness of each said customer segment to said promotions.

9. The method of claim 8 wherein said step of entering said market data includes providing null promotion data for individual said customer segments, said null promotion data being indicative of probabilities of achieving said business management objectives during an absence of said promotions.

10. The method of claim 1 further comprising a step of entering supply chain data on which said campaign plan is further based, said supply chain data being indicative of availability of resources that are subject matter of said promotions.

11. A system for forming a promotion campaign plan comprising:
stored customer segment information indicative of mapping a plurality of customers to a smaller number of customer segments, said mapping being based on attributes that are perceived as being relevant to customer activity when presented with promotions;
stored promotion information regarding a plurality of promotions;
stored market information regarding marketing considerations relevant to said promotions;
stored management information regarding business objectives and business constraints relevant to said promotions; and
an optimization engine configured to design a promotion campaign as an algorithmic response to each of said stored customer segment information, said stored promotion information, said stored market information and said stored management information, wherein said promotion campaign indicates promotion strategies on a promotion-by-promotion and segment-by-segment basis, said optimization engine being enabled to detect and automatically address inconsistencies and contradictions in achieving said business objectives and business constraints.

12. The system of claim 11 wherein said stored management information includes budget constraints for each said customer segment, said optimization engine being configured to be responsive to said budget constraints such that said promotion campaign includes designations of portions of specific said customer segments that are to be presented with particular said promotions.

13. The system of claim 11 wherein said optimization engine is cooperative with a feasibility engine that is configured to recognize and address said contradictions in said stored management information, said feasibility engine being enabled to determine resolutions to said contradictions that involve said business constraints.

14. The system of claim 11 further including stored supply data regarding availability of either or both of goods and services being offered to said customers.

15. The system of claim 14 wherein said stored supply data indicates on-hand inventory and currently ordered inventory.

16. The system of claim 11 wherein said optimization engine is cooperative with an efficiency frontier engine that is configured to recognize said inconsistencies and to determine trade-offs among said business objectives, said efficiency frontier engine being responsive to a hierarchy of said business objectives.

17. A method of determining differential promotion allocation among website visitors comprising the automated programming steps of:
entering market data that includes visitor conversion information and null promotion information, said conversion information being specific to visitor groups that are based on common attributes among said visitors, said conversion information identifying group-by-group characteristics relating to desired website visitor activities, said null promotion information identifying factors specific to said groups and said desired website visitor activities when there is an absence of promotions that are designed to promote said website visitor activities;
entering management data that includes business objectives and business constraints, said business objectives including information regarding target numbers of conversions and target revenue and profit levels, said business constraints including group-by-group budget constraints; and
computing a campaign plan that is specific to each said group and each said promotion, said campaign plan being based upon said market and management data.

18. The method of claim 17 further comprising entering supply data for use in said computing step, said supply data being indicative of goods or services that are offered to said website visitors.

19. The method of claim 18 wherein said computing step includes automatically detecting and addressing inconsistencies among said objectives.

20. The method of claim 17 wherein said computing step includes designating percentages for each said group and each said promotion, where each percentage represents the portion of said website visitors within a particular said group that will be presented with a particular said promotion, with at least some of said percentages being less than one hundred percent.
